(19) United States
(12) Patent Application Publication
(10) Pub. No.: US 2021/0227741 A1
(43) Pub. Date: Jul. 29, 2021

(54) GAUGE WHEEL COVER CROP CRIMPER

(71) Applicant: Rodney R. Heinen, Dawson, MO (US)

(72) Inventor: Rodney R. Heinen, Dawson, MO (US)

(21) Appl. No.: 16/752,417

(22) Filed: Jan. 24, 2020

(51) Int. Cl. A01B 49/04; A01C 7/00

(52) U.S. Cl. CPC A01B 49/04; A01C 7/006

(57) ABSTRACT

A planter implement (12) includes one or more row units (10) equipped with a furrowing assembly (22), a seed/fertilizer assembly (24), and a furrow-closing assembly (26). The unit (10) is equipped with a pair of right- and left-hand crimper wheels (30) respectively mounted on opposite sides of the furrowing assembly (22). Each crimper wheel (30) has a pair of support rims (52, 54) with a series of elongated bar elements (56) extending between and secured to the rims (52, 54). The bar elements (56) extend beyond the outer periphery of the rims (52, 54) in order to crimp surface crops as the row units (10) pass over a field; the bar elements (56) are oriented to direct material outwardly from each wheel (30) in order to prevent clogging thereof. The crimper wheels (30) are adjustably mounted on the row units (10) and serve as gauge wheels for the units (10).

### BACKGROUND OF THE INVENTION

### Field of the Invention

The present invention is concerned with improved earth-engaging agricultural implements equipped with a pair of laterally spaced apart, rotatable crimper wheels operable to crimp surface crops as the implement traverses a field. More particularly, the invention is concerned with such implements, the crimper wheels themselves, and corresponding methods; the crimper wheels preferably comprise substantially circular rims with a plurality of elongated, circumferentially spaced apart bar elements secured to said rims and extending outwardly beyond the outer margins of the rims. The crimper wheels also serve as gauge wheels for the implement.

### Description of the Prior Art

Many large-scale farming operations rely heavily on tillage for weed control. Tillage breaks up the soil to kill weeds and prepare for planting. However, intense tillage can compact the soil, cause erosion, and deplete soil nutrients; moreover, tillage is fuel- and labor-intensive. Consequently, some farmers are turning to cover crops in lieu of tillage for weed control. Cover crops, e.g., winter cereal rye or hairy vetch-triticale, are planted in the fall following cash crop harvesting; alternately, naturally occurring weeds and the like can serve as cover crops. The following Spring, the farmers make use of a roller crimper which mows the cover crop down and cuts or abrades the cover crop stems, terminating the growth thereof. This forms a matting or mulch of the cover crop, leaving a high amount of biomass on the soil surface. This matting blocks sunlight from reaching the soil surface, which inhibits weed establishment, and also provides a source of soil nutrients. Cash crop seeds can then be planted directly through the matting, which then grow up through the cover crop residue.

Conventional crimpers are generally in the form of large, elongated rollers having a series of outwardly extending, curved or chevron-pattern blades around the periphery thereof. Typically, the roller may be water-filled to increase its weight. In the use of such crimpers, it is usually necessary for a grower to make successive trips through a field, to first crimp the surface crop, and thereafter to plant seed. This is a time- and energy-intensive process.

Generally, large agricultural seed planters make use of rotatable coulters or trash wheels which initially open or otherwise condition the soil, along with a follower in the form of a dual-disk opener which serves to open a narrow furrow in the soil. A seed delivery assembly then deposits seed into the opened furrow. A follower closing wheel mechanism then closes the now-seeded furrow. In addition, these planters conventionally make use of gauge wheels in order to ensure that the depth of the furrow remains essentially constant as the implement passes through a field. Such gauge wheels may be in the form of resilient rubber-like tires, which are mounted adjacent or in spaced relationship to the disk opener.

### SUMMARY OF THE INVENTION

In one aspect of the invention, agricultural implements are provided, which comprise a soil-engaging device, such as a furrow opener, with a pair of rotatable, right- and left-hand crimper wheels respectively mounted on opposite sides of the device and operable to crimp surface crops astride the device as the implement traverses a field. Implements in accordance with the invention may include planters, fertilizers, drills, scarifiers, tillers, and any other type of soil-conditioning equipment. One class of preferred implements are seed planters, each including a furrow opener, mechanism for depositing seed in the open furrow, and a closing wheel assembly designed to close the seeded furrow. The crimper wheels in such planters serve the dual purpose of crimping surface crops while also functioning as gauge wheels. Moreover, these planters allow a grower to simultaneously crimp surface crops while seeding, thereby eliminating separate crimping and seeding operations.

The rotatable crimper wheels per se are also novel and comprise a pair of substantially circular, laterally spaced apart rims presenting outer margins, with a plurality of elongated, circumferentially spaced apart bar elements extending between and operatively secured to the rims, the bar elements extending radially outwardly beyond the outer margins of the rims; further, the bar elements are oriented to move cover crop, field trash, and earth outwardly to prevent clogging of the crimper wheels. Structure is further provided to rotatably mount the crimper wheels in an operative relationship on opposite sides of the implement. In preferred practice, the crimper wheels are designed so that the rims thereof lie in respective planes, with the bar elements mounted at a non-orthogonal angle relative to the planes; the bar elements are also longitudinally twisted along the lengths thereof. In this way, the crimper wheels provide a limited amount of up-and-down “bouncing” over the cover crop, in order to properly crimp the cover crop. This is to be contrasted with perpendicularly oriented bars which could create excessive “bouncing” which may affect seed depth.

In a related aspect of the invention, soil-treating methods are provided, comprising the steps of using an implement to engage the soil, and, during such soil-engaging step, using a pair of spaced-apart, rotatable crimper wheels of the type described above, mounted on the implement to crimp cover crop on opposite sides of the implement during passage through a field. In the context of planters, a furrow is first created, seed is deposited therein, followed by closing of the furrow. The crimper wheels serve to both crimp cover crop and as gauge wheels to substantially maintain furrow depth.

### BRIEF DESCRIPTION OF THE DRAWINGS

FIG. 1 is a side view of a planter row unit in accordance with the invention;

FIG. 2 is a perspective view of the row unit of FIG. 1, with the seed bin assembly removed to illustrate the side-mounted crimper wheels thereof;

FIG. 3 is a rear elevational view of the row unit of FIG. 1, with the seed bin and closing wheel assemblies removed, with the right-hand crimper wheel on the right, and the left-hand crimper wheel on the left;

FIG. 4 is a plan view of the row unit depicted in FIG. 3;

FIG. 5 is a perspective view of a right-hand crimper wheel in accordance with the invention, mounted on an adjustable support arm;

FIG. 6 is a perspective view similar to that of FIG. 5, without the adjustable support arm;

FIG. 7 is a plan view of the crimper wheel of FIG. 6;

FIG. 8 is a partially exploded, perspective view of a crimper wheel as illustrated in FIG. 6; and

FIG. 9 is a top view of a multiple-row implement having the row units of FIGS. 1-4, depicting mounting of the respective row units so as to crimp substantially all of the cover crop on a swath of field, as the implement traverses the swath.

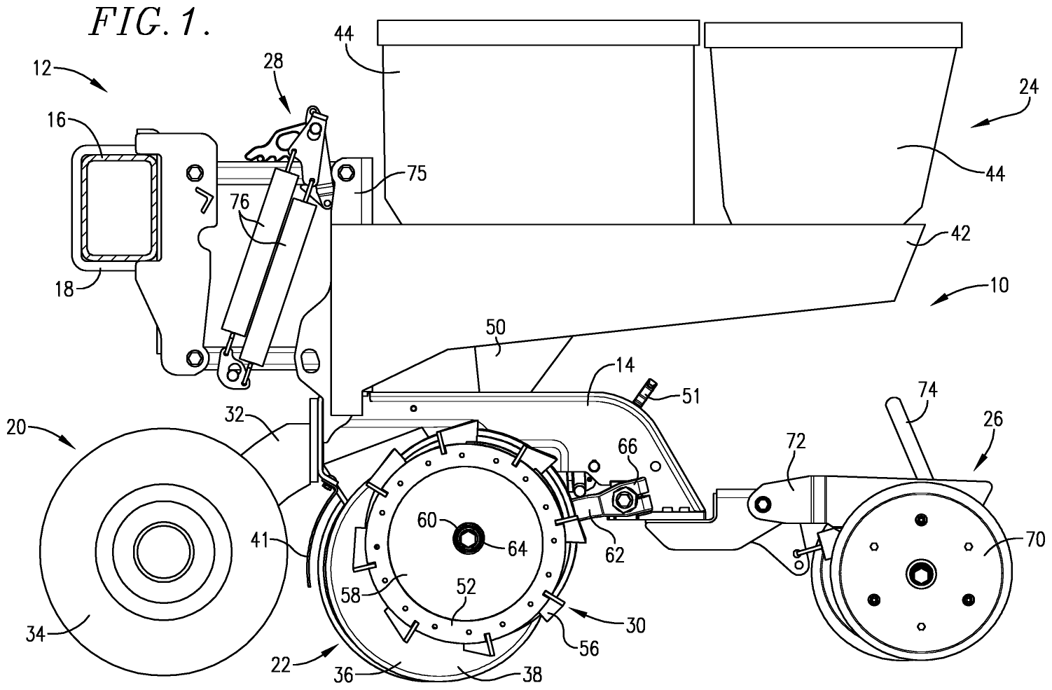

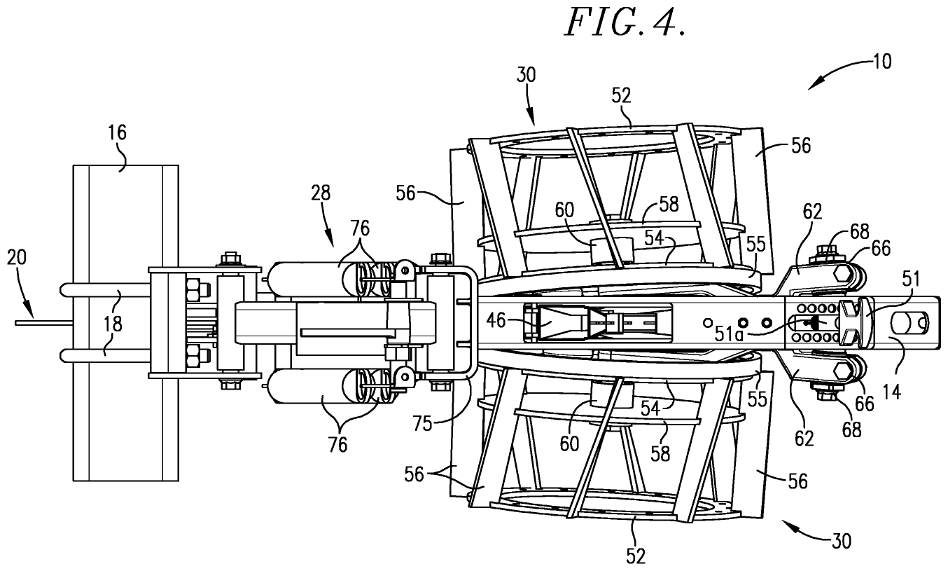

While the drawings do not necessarily provide exact dimensions or tolerances for the illustrated components or structures, FIGS. 1-8 are to scale with respect to the relationships between the components of the structures illustrated therein.

### DETAILED DESCRIPTION OF THE PREFERRED EMBODIMENT

Turning now to the drawings, and particularly FIG. 1, a row unit 10 forming a part of a planter implement 12 is illustrated in FIG. 1. Generally, a plurality of such row units would be used in an overall planter, in order to plant successive rows of seed in a field. Broadly, the row unit 10 includes a fore-and-aft extending unit body 14 which supports the various assemblies of the unit and is attached to a tool bar 16 by means of U-bolts 18 or similar expedients. In more detail, the unit body 14 is equipped with a forward coulter assembly 20, an intermediate furrowing assembly 22, a seed fertilizer assembly 24, a rearmost furrow-closing assembly 26, and a parallel arm assembly 28. The assembly 22 includes a pair of specialized crimper wheels 30 on opposite sides thereof, which are important for purposes to be explained.

The coulter assembly 20 is itself conventional and includes a forwardly extending arm 32, which rotatably supports an earth-penetrating coulter blade 34 serving to initially open the soil as the row unit 10 traverses a field. In alternate forms, the arm 32 can support one or more trash-clearing disks (not shown) in lieu of blade 34. As used herein, “coulter” is generic to all types of forward soil-opening or conditioning devices.

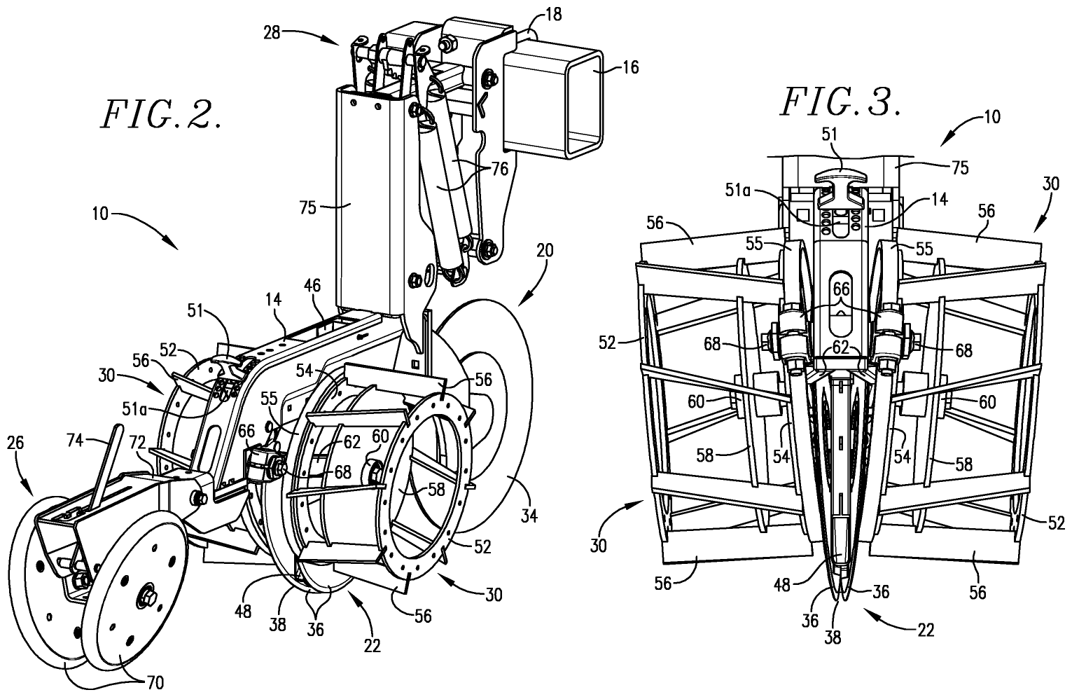

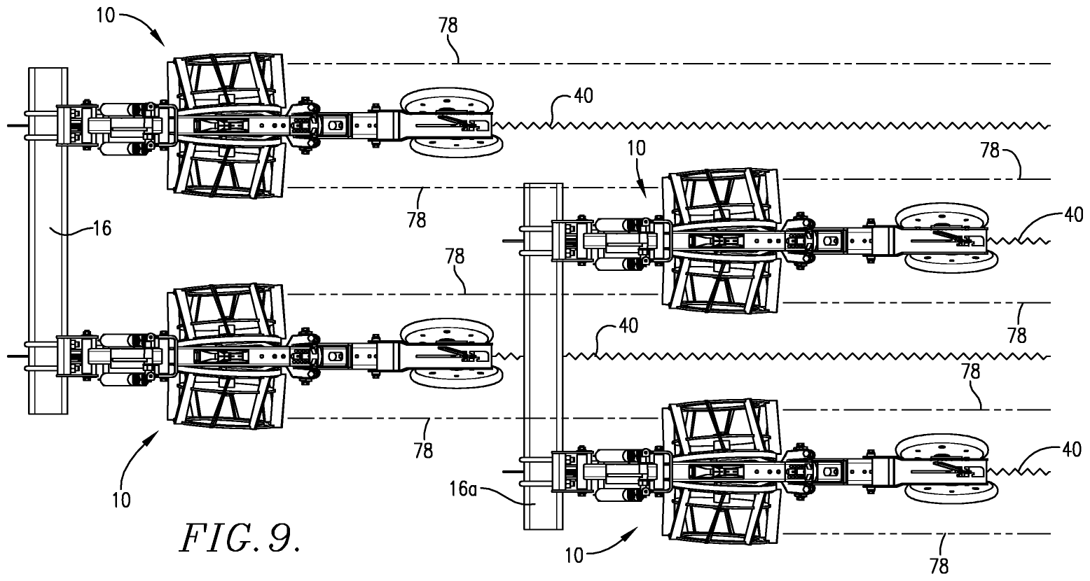

The furrowing assembly 22 includes a pair of inclined, converging, rotatable disks 36, which lie in individual, converging planes so as to present a generally V-shaped base 38. The purpose of the disks 36 is to open a furrow 40 (see FIG. 9) in the earth during travel of the row unit 10. A guard 41 is provided adjacent the forward margins of the disks 36 to minimize buildup of vegetation or trash between the disks. The seed/fertilizer assembly 24 is operatively coupled with the furrowing assembly 22 in order to deliver seed and/or fertilizer into the furrow 40. In particular, the assembly 24 includes a support shelf 42 supporting one or more fillable bins 44. As best illustrated in FIG. 2, the unit body 14 presents an open-top delivery throat 46 extending downwardly and communicating with a delivery tube 48, which lies between the disks 36. The bottom outlets of the bins 44 are in operative communication with the throat 46 via a chute 50 (FIG. 1) so as to deliver seed and/or fertilizer into the furrow 40 via tube 48.

The operating depth of the disks 36 can be adjusted by means of a conventional mechanism 51 having predetermined adjustment openings 51a. As is well understood in the art, the disks 36 can thus be up-or-down adjusted so as to create furrows 40 of greater or lesser depth as desired.

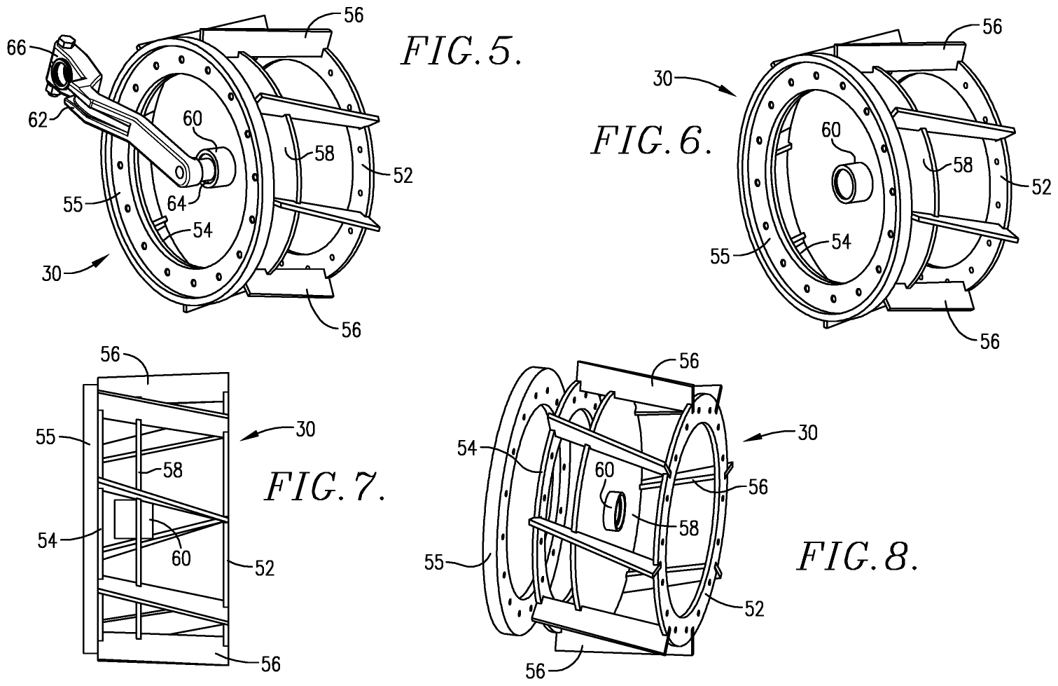

As mentioned previously, the assembly 22 is equipped with a pair of side-mounted crimper wheels 30, which are rotatably mounted on opposite sides of the disks 36. The crimper wheels are handed, i.e., right-hand and left-hand wheels are respectively mounted on corresponding sides of the assembly 22. As best illustrated in FIGS. 5-8, each crimper wheel 30 includes a pair of substantially annular, laterally spaced apart support rims 52 and 54 with a series of elongated, circumferentially spaced apart bar elements 56 extending between and secured to the rims 52, 54; a synthetic resin wear rim 55 is secured to the outer face of support rim 54, as best seen in FIGS. 6-8. As illustrated, the bar elements 56 are longitudinally twisted along the lengths thereof and are at non-orthogonal angles relative to the planes of the rims 52, 54. Moreover, it will be seen that the bar elements 56 extend outwardly beyond the outer peripheries of the rims 52, 54, and are oppositely angularly oriented in the right-hand and left-hand wheels. An intermediate reinforcing plate 58 is provided between the rims 52, 54 and is likewise secured to the bar elements 56. The plate 58 is equipped with a central hub 60 so as to permit rotatable mounting of the crimper wheels 30 to the row unit 10.

Each crimper wheel 30 is mounted on a side of the unit body 14 by means of an adjustable mounting arm 62; normally, the arms 62 support conventional gauge rollers or tires, but are used in the context of the present invention to support the wheels 30. One end of the arm 62 has a bearing 64 received within the hub 60 of the associated crimper wheel 30, whereas the other end has a socket 66 which is secured to a corresponding mounting stud 68. In this way, the height of the respective crimper wheel 30 may be adjusted, thereby allowing the wheels to function as gauge wheels, as will be explained.

The furrow-closing assembly 26 is also conventional and includes a pair of V-oriented closing disks 70. These disks 70 are supported on a trailing leg 72 secured to unit body 14 and are adjustable by means of a lever 74.

Similarly, the parallel arm assembly 28 is well known, and includes an upright 75 and a pair of side-by-side spring units 76 serving to maintain the row unit in a level condition as it traverses a field.

### Operation

The general operation of row unit 10 can readily be understood from the foregoing description. As the row unit traverses a field, the earth is first penetrated or conditioned by means of coulter 34 of assembly 20, followed by opening of the furrow 40 by the disks 36 of assembly 22. As the furrow 40 is opened, seed and/or fertilizer is deposited in the furrow 40 through the delivery tube 48. Finally, the furrow-closing assembly 26 serves to close the now-seeded and/or fertilized furrow 40. During this operation, the crimper wheels 30 come into play in order to crimp surface crop on either side of the disks 36, by virtue of the protrusion of each of the bar elements 56 outwardly beyond the margins of the rims 52, 54. Additionally, the handed orientation of the bar elements 56 serves to expel cover crop and other materials outwardly in both directions to inhibit or eliminate clogging of the disks 36. At the same time, the wheels 30 serve as gauge wheels in order to substantially maintain the depths of the disks 36. Consequently, the normally separate operations of surface crop crimping and seeding (and/or fertilizing) can be simultaneously performed.

FIG. 9 illustrates a portion of a large planter implement having a plurality of row units 10. The latter are arranged so as to substantially completely crimp the entire swath of field traversed by the planter implement. As depicted, there are two tiers of row units 10 mounted on individual, spaced apart tool bars 16 and 16a. Note that the row units mounted on the trailing tool bar 16a are laterally offset and between a pair of row units mounted on leading tool bar 16. This arrangement serves to crimp the entire swath of field. Thus, each row unit crimps an area bounded by the coverage lines 78, with a slight overlap between adjacent lines. The regions of the furrows 40 are effectively crimped owing to the passage of the disks 36 and 70. Although not shown, those skilled in the art appreciate that a large implement such as that illustrated in FIG. 9 will be equipped with a series of ground wheels. Such ground wheels will of course flatten surface crops as the implement moves along the field. However, if desired, smaller width crimper wheels may be mounted in a trailing relationship to these ground wheels, to thereby ensure full crimping of the field swath.

The present invention provides appropriate crimping of cover crop without complete cutting or severing thereof. This is particularly the case where planting is carried out during the crimping operation. That is, crimping is done in the direction of planting, thus avoiding cross-cutting of the cover crop. This is to be contrasted with prior art techniques where planting and crimping are separately carried out. The resultant sequential field passages for crimping and seeding may result in cross-cutting because the separate field passages can be at an angle or even perpendicular to each other, and the cross-cut cover crop will then grow back, interfering with growth of the cash crop.

I claim:

1. An agricultural crimper wheel, comprising:
a pair of substantially circular, laterally spaced apart rims presenting outer margins;
a plurality of elongated, circumferentially spaced apart bar elements extending between and operatively secured to said rims, said bar elements extending radially outwardly beyond the outer margins of said rims; and
structure operable to rotatably mount said crimper wheel in an operative relationship on an implement in order to crimp surface crops during rotation of said wheel as the implement traverses a field.

2. The crimper wheel of claim 1, said rims lying in respective planes, said bar elements being at a non-orthogonal angle relative to said planes.

3. The crimper wheel of claim 1, said bar elements being longitudinally twisted along the lengths thereof.

4. The crimper wheel of claim 1, said rotatable mounting structure comprising a mounting plate located between said rims and including a central hub.

5. The crimper wheel of claim 4, said mounting plate secured to said bar elements intermediate the ends thereof.

6. The crimper wheel of claim 1, including a reinforcing plate mounted adjacent one of said rims.

7. The crimper wheel of claim 1, the lateral distance between said rims being shorter than the outer diameter of the rims.

8. The gauge and crimper wheel of claim, 1, the region between said bar elements being open.

9. The crimper wheel of claim 1, said mounting structure including apparatus for adjusting the height of said wheel when mounted on an implement.

10. An agricultural implement, comprising:
a soil-engaging device; and
a pair of rotatable crimper wheels respectively mounted on opposite sides of said device and operable to crimp surface crops astride said device as the implement traverses a field.

11. The implement of claim 10, said implement being a planter and including apparatus operable to create a furrow in the soil and to deposit seed into said furrow.

12. The implement of claim 11, said crimper wheels substantially maintaining the depth of said furrow as the implement traverses said field.

13. The implement of claim 10, said crimper wheels comprising:
a pair of substantially circular, laterally spaced apart rims presenting outer margins;
a plurality of elongated, circumferentially spaced apart bar elements extending between and operatively secured to said rims, said bar elements extending radially outwardly beyond the outer margins of said rims; and
structure operable to rotatably mount said crimper wheels in an operative relationship on said implement.

14. The implement of claim 13, said rims lying in respective planes, said bar elements being at a non-orthogonal angle relative to said planes.

15. The implement of claim 13, said bar elements being longitudinally twisted along the lengths thereof.

16. The implement of claim 13, the bar elements of said crimper wheels being oppositely angularly oriented, respectively.

17. The implement of claim 13, said rotatable mounting structure comprising a mounting plate located between said rims and including a central hub.

18. The implement of claim 17, said mounting plate secured to said bar elements intermediate the ends thereof.

19. The implement of claim 13, the region between said bar elements being open.

20. The implement of claim 11, said furrow-creating device including a pair of side-by-side disks oriented in individual converging planes so as to present a generally V-shaped base adjacent the bottom edges of the device.

21. A method of treating soil, comprising the steps of:
using an implement to engage the soil; and
during said soil-engaging step, using a pair of spaced-apart, rotatable crimper wheels mounted on said implement to crimp cover crop on opposite sides of the implement.

22. The method of claim 21, said crimper wheels being mounted on said implement so as to permit adjustment of the height thereof.

23. The method of claim 21, said implement operable to create a furrow in the soil, said crimper wheels operable to substantially maintain the depth of said furrow created by said implement.

24. The method of claim 21, each of said crimper wheels comprising:
a pair of substantially circular, laterally spaced apart rims presenting outer margins; and
a plurality of elongated, circumferentially spaced apart bar elements extending between and operatively secured to said rims, said bar elements extending radially outwardly beyond the outer margins of said rims.

25. The method of claim 24, said rims lying in respective planes, said bar elements being at a non-orthogonal angle relative to said planes.

26. The method of claim 24, including a mounting plate secured to said bar elements intermediate the ends thereof and having a central hub.

27. The method of claim 24, the lateral distance between said rims being shorter than the outer diameter of the rims.

28. The method of claim 24, the bar elements of said crimper wheels being oppositely angularly oriented, respectively.

29. The method of claim 21, said implement being a planter, and including the steps of creating a furrow in the soil, and depositing seeds in said furrow, said rotatable crimper wheels operable to crimp cover crop on opposite sides of said furrow.
